(19) United States
(12) Patent Application Publication
(10) Pub. No.: US 2022/0096291 A1
(43) Pub. Date: Mar. 31, 2022

(54) HOVERBOARD WHEELCHAIR RIGGING ATTACHMENT APPARATUS

(71) Applicant: Robert Haenel, Las Vegas, NV (US)

(72) Inventor: Robert Haenel, Las Vegas, NV (US)

(21) Appl. No.: 17/039,541

(22) Filed: Sep. 30, 2020

(51) Int. Cl. A61G 5/04; B62K 11/00; B62K 27/12

(52) U.S. Cl. CPC A61G 5/047; B62K 27/12; B62K 11/007

(57) ABSTRACT

A hoverboard rigging attachment apparatus to motorize a standard wheelchair using a hoverboard. The apparatus has a principal support having a vertical stem, a pair of arms, and a hoverboard clamp attachment on a base of the principal support. The hoverboard clamp attachment is removably disposed on a hoverboard clamp disposed on a middle of a hoverboard such that it is completely fixed. A pair of wheelchair clamps is disposed on a distal end of each of the pair of arms secured by a spring-loaded mechanism. Each of the pair of wheelchair clamps is removably disposed on a leg of a wheelchair. A user sits on the wheelchair and places her feet on the platforms of the hoverboard. A kill switch is in operational communication with the hoverboard and may be disposed on the wheelchair, wherein the kill switch is configured to cut power to the hoverboard.

### CROSS-REFERENCE TO RELATED APPLICATIONS

U.S. 62/908,517

U.S. Ser. No. 10/286,977B1

### FEDERALLY SPONSORED RESEARCH

None

### SEQUENCE LISTING

None

### TECHNICAL FIELD OF INVENTION (FOI)

This present disclosure relates generally to a personal propulsion device. More specifically, this invention relates to wheelchair accessories and rigging, namely, a universal coupling device designed to releasable and securely attach a motorized personal propulsion device, commonly known as a Hoverboard, to a manually powered wheelchair. Other improvements in the design of a Hoverboard coupling or rigging device are also included.

### BACKGROUND

Various types of coupling devices are known for wheelchair rigging. However, existing motorized Wheelchairs are expensive and is needed, and what the present hoverboard Wheelchair attachment apparatus provides, is a means of motorizing a traditional Wheelchair using another piece of easily acquired technology: a hoverboard.

What is needed is a principal support having a main stem, a joint, a pair of arms, a hoverboard clamp, and a pair of Wheelchair clamps to join the hoverboard to the Wheelchair.

It can be seen, therefore, that there is a device needed to enable an individual to secure a motorized personal propulsion device to a wheelchair with a simple, cost-effective design.

### SUMMARY

This present disclosure has overcome the disadvantages and shortcomings of the prior art by implementing a universal adjustable coupling device capable of widespread commercial application by its simplified and cost-effective design.

The general purpose of the present hoverboard Wheelchair attachment apparatus, described subsequently in greater detail, is to provide a hoverboard Wheelchair attachment apparatus and rigging that has many novel features that result in a hoverboard attachment apparatus that is not anticipated, rendered obvious, suggested, or even implied by prior art, either alone or in combination thereof.

This present disclosure includes: a horizontal bar, a vertical bar, and a plurality of attachment means.

A horizontal bar is comprised of an adjustable bar comprised of a light and strong metal alloy such as Tungsten, Aluminum, or other material commonly used in the art, with an attachment means disposed on both terminating ends. The adjustable bar is comprised of three integrated hollow tubes and a length adjustment means. The three integrated hollow tubes are a central tube, a right tube, and a left tube. The central tube has a diameter greater than the right tube and left tube, enabling the desired length of the proximal end of both tubes to fit inside the central tube. In one embodiment the length adjustment means is comprised of a spring apparatus equidistantly spaced and configured to adjust the length of the right and left tube's proximal end. A spring-loaded mechanism designed to adjust to the variable length of various wheelchair widths at a desired articulation point to an embodiment.

The plurality of attachment means on the horizontal bar are generally “C” shaped with a top, a bottom, an inward face, and integrated into the distal end of both tubes. In one embodiment, the top has a screw aperture configured to receive an adjustable tension hand screw. The attachment means is designed to partially encapsulate a secure portion of a motorized personal propulsion device such as a hoverboard. A user will then rotate the adjustable tension screw downward until sufficient pressure is applied to prevent detachment.

The present hoverboard wheelchair attachment apparatus includes a principal support having a stem and a pair of arms disposed on a joint thereof. The stem and each of the pair of arms optionally have an adjustment mechanism, wherein the adjustment mechanism is configured to change a length of each of the stem and the pair of arms.

The adjustment mechanism can be, but is not limited to, a plurality of apertures and a pin. The hoverboard clamp is configured to be rotatably and removably disposed on a hoverboard clamp that is disposed on a middle of a hoverboard such that it is completely fixed and secure.

A pair of wheelchair clamps is rotatably disposed on a distal end of each of the pair of arms. In one embodiment, each of the pair of Wheelchair clamps is a C-shape that is selectively engageable with a rigging of a Wheelchair. In an alternative embodiment, each of the pair of Wheelchair clamps is removably disposed on the leg of the Wheelchair such that it is completely fixed and secure.

A user sits in the wheelchair and places his or her feet onto a pair of platforms of the hoverboard. A throttle mechanism in operational communication with the hoverboard may optionally be disposed on the Wheelchair, wherein the throttle mechanism is configured to control the throttle of the hoverboard.

A kill switch in operational communication with the hoverboard may optionally be disposed on the Wheelchair, wherein the kill switch is configured to cut power to the hoverboard. A braking mechanism that is in operational communication with the hoverboard may also be disposed on the wheelchair.

These and other features, aspects, and advantages of the invention will be further understood and appreciated by those skilled in the art by reference to the following written specification, claims and disclosure drawings.

### BRIEF DESCRIPTION OF DRAWINGS

An embodiment of the present invention will hereinafter be described in conjunction with appended drawings, provided to illustrate and not to limit the invention. Drawings included in this Non-Provisional patent application are illustrative of the present disclosure, method, and designs. The Figure descriptions below illustrate the drawing intent and objective but do not relate specifically to any current drawing or embodiment of the present invention and the inventor reserves the right to update, modify, amend or revoke any of the depicted drawings in anticipation of this Non-Provisional patent application.

FIG. 1 is an isometric view of the a hoverboard wheelchair attachment and rigging apparatus attached to a hoverboard propulsion device.

FIG. 2 is a top plan view of the hoverboard wheelchair rigging attachment apparatus.

### DETAILED DESCRIPTION OF DRAWINGS

This present disclosure will be described in detail with reference to embodiments thereof as illustrated in the accompanying drawings and figures, in which like reference numerals are used to indicate identical or functionally similar elements. References to “one embodiment”, “an embodiment”, “an example embodiment”, etc., indicate that the embodiment described may include a particular feature, structure, or characteristic, that every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present invention. Other suitable modifications and adaptations of the variety of conditions and parameters normally encountered in the field, and which would be apparent to those skilled in the art, are within the spirit and scope of the invention.

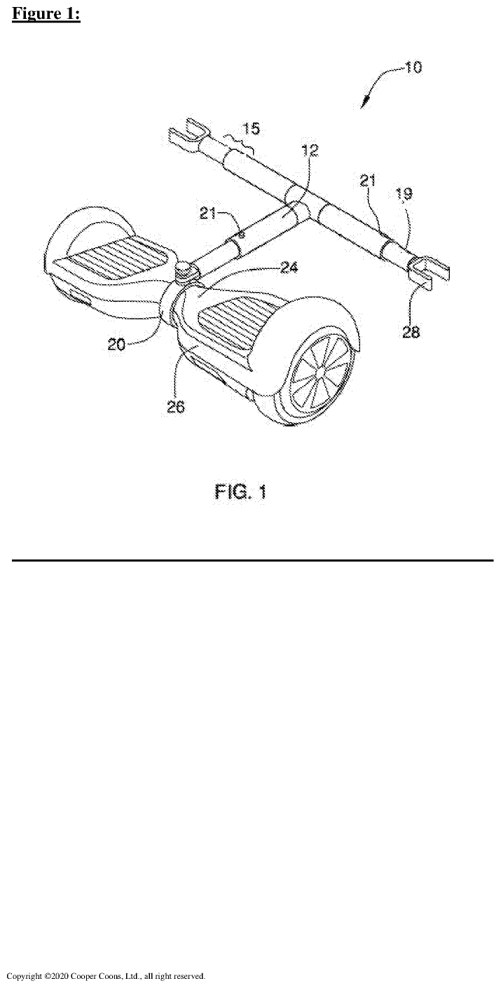

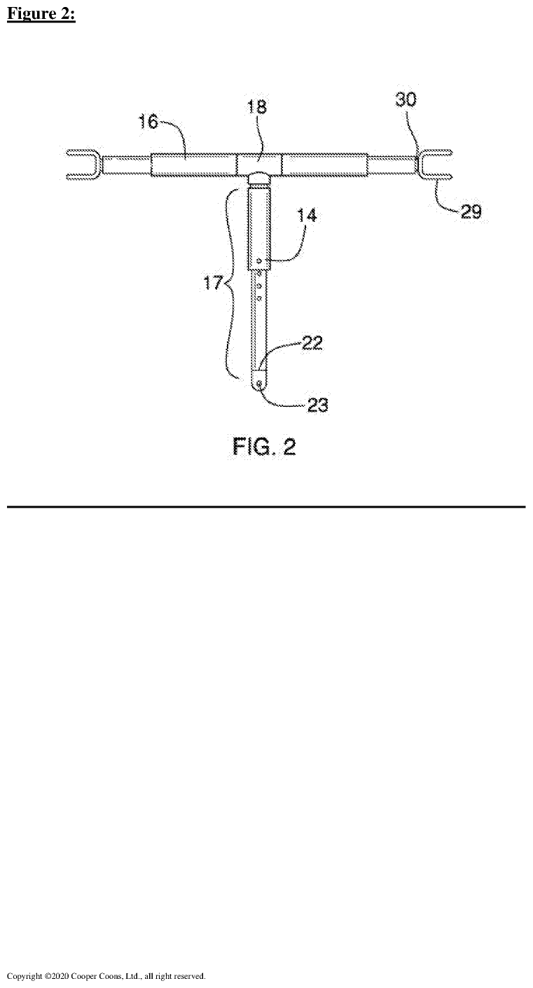

With reference now to the drawings, and in particular FIGS. 1 and 2 thereof, an example of the instant hoverboard wheelchair attachment apparatus employing the principles and concepts of the present hoverboard wheelchair attachment apparatus and generally designated by the reference number 10 will be described.

Referring to FIGS. 1 through 8 the present hoverboard wheelchair attachment apparatus 10 is illustrated. The hover-board wheelchair attachment apparatus 10 includes a principal support 12 having a stem 14 and a pair of arms 16 disposed on a joint 18 thereof. The stem 14 and each of the pair of arms 16 optionally have an adjustment spring loaded mechanism 15, wherein the adjustment mechanism is configured to change a length 17 of each of the stem and the pair of arms. The adjustment mechanism can be, but is not limited to, an internal spring-loaded mechanism to allow cross bar 19 and to adjust to a variable length 21. A hoverboard clamp attachment 23 is disposed on a base 22 of the principal support 12. The hoverboard clamp attachment is configured to be rotatably and removably disposed on a hoverboard clamp 20 that is removably disposed on a middle 24 of a hoverboard 26 such that it is completely fixed and secure. A pair of wheelchair clamps, that may include, but not limited to, a screw clamp embodiment 28 is disposed on a distal end 30 of each of the pair of arms 16. In an ideal embodiment of the invention, each of the pair of wheelchair clamps 28 is a C-shape 29 that is selectively engageable with a leg 31 of a wheelchair 32. In an alternative embodiment of the invention, each of the pair of wheelchair clamps is removably disposed on the wheelchair such that it is completely fixed and secure. A user sits in the wheelchair and places his or her feet onto a pair of platforms of the hoverboard 26. A kill switch in operational communication with the hoverboard 26 may be disposed on the wheelchair, wherein the kill switch is configured to cut power to the hoverboard.

I claim:

1. A hoverboard wheelchair attachment and rigging apparatus comprising:
a principal support having a stem and a pair of arms disposed on a joint thereof;
a hoverboard clamp attachment disposed on a base of the principal support, wherein the hoverboard clamp attachment is configured to be pivotably and removably disposed on a hoverboard clamp disposed on a middle of a hoverboard;
and a pair of wheelchair clamps, wherein each of the pair of wheelchair clamps is disposed on a distal end of each of the pair of arms such that each of said wheelchair clamps is positioned outwardly offset from said hoverboard when the principal support is unpivoted and the pair of arms are parallel to the hoverboard, wherein each of the pair of wheelchair clamps is removably disposed on respective lateral upright sections of a frame of a wheelchair wherein said hoverboard is positioned centrally between said lateral upright sections of said frame of said wheelchair;
and said wheelchair clamps to include screw in support connection at a certain articulation point to a wheelchair in one embodiment.

2. A hoverboard wheelchair attachment apparatus comprising:
a principal support having a stem and a pair of arms disposed on a joint thereof, wherein the stem and each of the pair of arms have an adjustment mechanism, wherein the adjustment mechanism is configured to change a length of each of the stem and the pair of arms;
a principal support stem with an internal spring system to accommodate for variable lengths of wheelchair widths and articulation points;
a hoverboard clamp attachment disposed on a base of the principal support, wherein the hoverboard clamp attachment is configured to be pivotably and removably disposed on a hoverboard clamp disposed on a middle of a hoverboard;
and a pair of wheelchair clamps, wherein each of the pair of wheelchair clamps is rotatably disposed on a distal end of each of the pair of arms such that said wheelchair clamps are extendable to a positions laterally offset outwardly from the hoverboard when the principal support is unpivoted and said pair of arms are positioned parallel with the hoverboard, wherein each of the pair of wheelchair clamps is selectively engageable with respective lateral sections of a frame of a wheelchair wherein said hoverboard is positioned centrally between said lateral upright sections of said frame of said wheelchair.
